(19) United States
(12) Patent Application Publication
(10) Pub. No.: US 2015/0361918 A1
(43) Pub. Date: Dec. 17, 2015

(54) DEVICE FOR CONTROLLING A FUEL INJECTOR

(71) Applicants: Hyundai Motor Company, Seoul (KR); Kia Motors Corporation, Seoul (KR)

(72) Inventors: Choong Seob PARK, Suwon-Si (KR); Hyung Ju LEE, Yongin-Si (KR); Hak Mo YOO, Suwon-Si (KR); Ji Haeng LEE, Namyangju-si (KR); Doo Jin JANG, Seoul (KR); Kang Hee CHO, Suwon-Si (KR); Young Jae KIM, Gunpo-Si (KR)

(73) Assignees: KIA MOTORS CORPORATION; HYUNDAI MOTOR COMPANY

(21) Appl. No.: 14/507,479

(22) Filed: Oct. 6, 2014

(30) Foreign Application Priority Data
Jun. 17, 2014 (KR) 10-2014-0073549

(51) Int. Cl. F02D 41/40

(52) U.S. Cl. CPC F02D 41/401

(57) ABSTRACT

A device for controlling a fuel injector driving is disclosed, which relates to a technology for enabling a drive semiconductor to actively control a drive current in response to a load condition of an output terminal of an injector when an injector for fuel injection is driven. The device for controlling a fuel injector includes: a micro control unit (MCU) configured to generate a drive signal for controlling a fuel injector operation; a drive semiconductor configured to sense a current flowing in the fuel injector, to measure a time period at which the sensed current arrives at a target current value, and to change a drive current setting value of a current driver in response to a result of a comparison between the measured time period and a predetermined time period; and an injector driver configured to operate the fuel injector in response to an output current of the current driver.

### CROSS-REFERENCE TO RELATED APPLICATION

This application claims priority and the benefit of Korean patent application No. 10-2014-0073549 filed in the Korean Intellectual Property Office on Jun. 17, 2014, the entire contents of which are herein incorporated by reference.

### BACKGROUND

Embodiments of the present disclosure relate to a device for controlling injector driving, and more particularly to a technology for enabling a drive semiconductor to actively control a drive current in response to a load condition of an output terminal of an injector when an injector for fuel injection is driven.

Recently, a vehicle engine receives data from various sensors of the engine during fuel supply. An electronic control unit (ECU) mounted to vehicles determines an amount of fuel on the basis of the received data, and supplies the determined amount of fuel to the vehicles using an injector configured for fuel injection.

A fuel injector for supplying/injecting a fuel is mounted to the vehicle engine system. Specifically, an injector for directly injecting fuel into a combustion chamber is mounted to diesel engine vehicles.

A common rail system serving as one example of the fuel injection device can provide a fuel to a rail using a high-pressure pump. In addition, the ECU receives pressure of the rail from a pressure sensor so as to control the rail pressure, and is configured to inject fuel by transmitting a fuel injection signal.

This common rail system mounts an accelerometer to the center part of an engine block, learns a signal generated from the accelerometer every hour, and adjusts the amount of pilot fuel in response to an injector status.

Although the same injector repeatedly injects a small amount of fuel, the amount of fuel injection needs to be managed within a predetermined deviation range in such a manner that the common rail system can satisfactorily perform original functions, such that it is very important to manage the amount of fuel pilot injection or that of fuel post injection.

Since the new Euro 6 (Euro 6+) emission regulations will become effective in 2017 in Europe, many automobile companies of advanced countries are conducting intensive research into new technologies capable of meeting the stringent Euro 6+ emission regulations.

The kernel of the Euro 6+ emission regulations involves more stringent rules regarding exhaust pollutant emissions or fine dust emissions. A core technology for reducing the amount of exhaust pollutant emissions or fine dust emissions is a multi-injection technology.

The multi-injection technology is configured to divide one fuel injection time into several fuelling times so as to provide a small amount of fuel to the vehicle engine during each fuelling time, instead of simultaneously providing a large amount of fuel to the vehicle engine. As a result, the multi-injection technology has advantages in that exhaust pollutant emissions or fine dust emissions can be greatly reduced.

A core technology of the multi-injection technology aims to correctly inject a smaller amount of fuel into the engine during a shorter fuelling time as compared to the conventional art, so that it is necessary for the multi-injection technology to precisely control the injector designed for fuel injection.

However, a general injector driving device has been configured to drive an injector drive switch using a fixed amount of an initial setting current. That is, the conventional injector driving device has been configured to receive a current level setting value of a driver from a main Micro Control Unit (MCU) during the initial setting process. In addition, the conventional injector driving device determines whether an injector drive current arrives at a target level using a current sensor, and controls only the on/off operations of the driver according to the determined result.

Accordingly, it is impossible for the general injector driving device to properly cope with variation in a turn-on resistance of a drive switch (Power metal-oxide-semiconductor field-effect transistor (MOSFET)) or variation in capacitance of a gate capacitor. In addition, the turn-on time point of the drive switch may be changed according to load variation of a pre-driver of the drive semiconductor. In addition, a deviation may occur in a turn-on time between drive channels of the injector, and the conventional injector driving device has difficulty in correctly compensating for such timing deviation.

### BRIEF SUMMARY

Various implementations of the present disclosure are directed to providing a device for controlling injector driving that substantially obviates one or more problems due to limitations and disadvantages of the related art.

An exemplary implementation of the present disclosure relates to a technology for changing a drive current value of a pre-driver by monitoring a specific time during which a current flowing in an injector arrives at a target current value, so that a drive semiconductor can actively drive the injector.

In accordance with an aspect of the present disclosure, a device for controlling an injector includes: a micro control unit (MCU) configured to generate a drive signal for controlling an injector operation; a drive semiconductor configured to sense a current flowing in the injector, to count a time at which the sensed current arrives at a target current value, and to change a drive current setting value of a current driver in response to a result of a comparison between the counted time and a predetermined time; and an injector driver configured to operate the injector in response to an output current of the current driver.

In accordance with another aspect of the present disclosure, a device for controlling an injector includes: a current sensor configured to sense a drive current of the injector; a time counter configured to measure a time during which the drive current sensed by the current sensor arrives at a target current value; an injector controller configured to compare the time measured by the time counter with a predetermined time value, and change a drive current setting value according to the result of comparison; and a driver configured to provide a changed drive current to an injector driver for driving the injector in response to the drive current setting value.

It is to be understood that both the foregoing general description and the following detailed description of the present disclosure are exemplary and explanatory and are intended to provide further explanation of the present disclosure as claimed.

### BRIEF DESCRIPTION OF THE DRAWINGS

FIG. 1 is a block diagram illustrating an injector driving control device according to the present disclosure.

FIG. 2 is a detailed circuit diagram illustrating a drive semiconductor shown in FIG. 1.

FIG. 3 is a timing diagram including a plurality of graphs illustrating operations of a drive semiconductor shown in FIG. 2.

FIG. 4 is a flowchart illustrating operations of the injector driving control device according to the present disclosure.

### DETAILED DESCRIPTION OF EMBODIMENTS

Reference will now be made in detail to the implementations of the present disclosure, examples of which are illustrated in the accompanying drawings. Wherever possible, the same reference numbers will be used throughout the drawings to refer to the same or like parts.

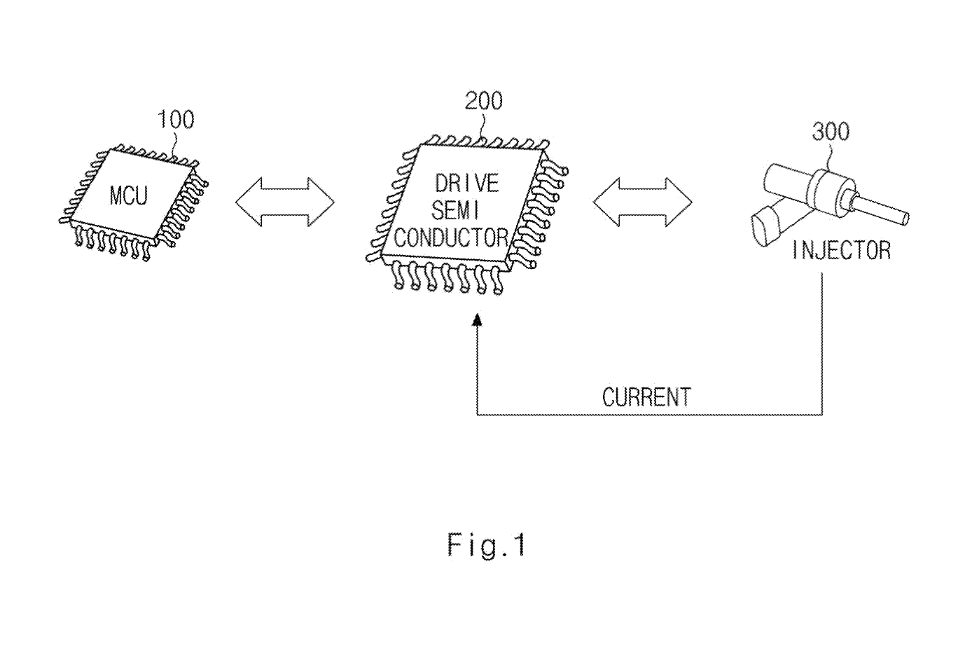

FIG. 1 is a block diagram illustrating an injector driving control device according to the present disclosure.

Referring to FIG. 1, the injector driving control device includes a micro control unit (MCU) 100, a drive semiconductor 200, and an injector 300.

The MCU 100 is configured to receive an interface signal from the drive semiconductor 200, and to generate a drive signal for controlling operations of the injector 300.

The drive semiconductor 200 is configured to coordinate (or adjust) a drive current of the injector 300 in response to a drive signal received from the MCU 100, and then output a drive control signal. The drive semiconductor 200 detects a specific signal indicating drive characteristics of the injector 300, performs a calculation using the detected signal, and based on results of the calculation adjusts the drive current of the injector 300.

In other words, the drive semiconductor 200 detects characteristics of the injector 300 whenever a power MOSFET of the injector 300 is turned on, and then directly coordinates a drive current of the injector 300 on the basis of the detected information during the next injection operation.

The injector 300 performs fuel injection under the condition that the amount of a drive current is adjusted in response to a drive control signal received from the drive semiconductor 200. In addition, the injector 300 may output a signal indicating drive characteristics to the drive semiconductor 200. In this case, the signal indicating drive characteristics of the injector 300 may be denoted by a voltage or current consumed by injection of the injector 300. The injector driving control device according to the implementations can allow the drive semiconductor 200 to monitor a current flowing in the injector 300, so that the drive semiconductor 200 can adjust a drive current of the injector 300.

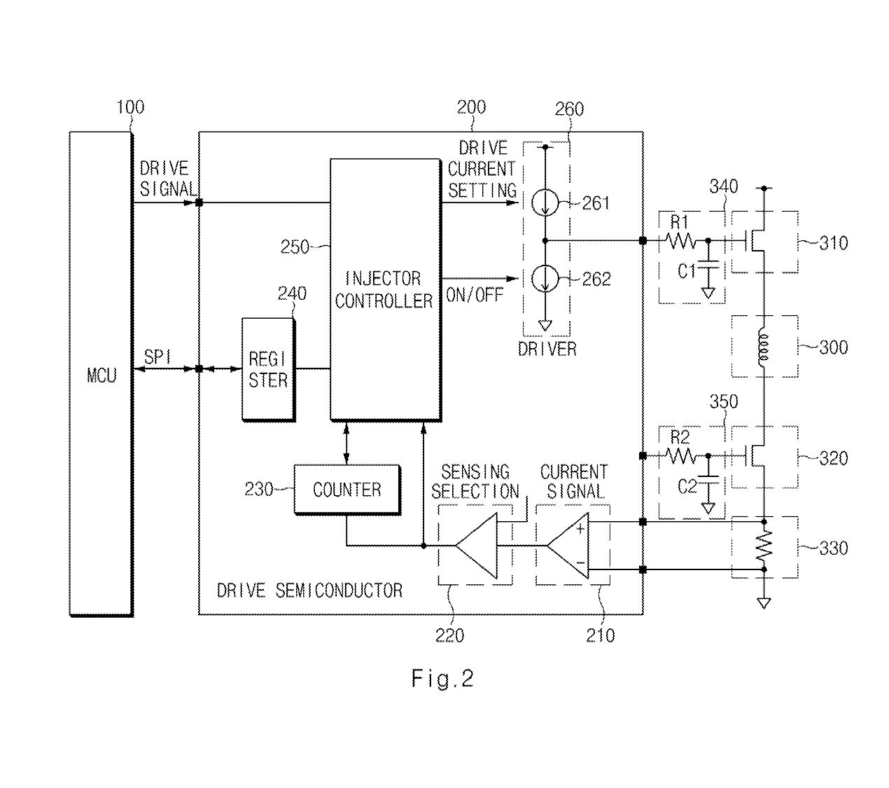

FIG. 2 is a detailed circuit diagram illustrating the drive semiconductor 200 shown in FIG. 1.

Referring to FIG. 2, the drive semiconductor 200 includes a current sensor 210, a selection unit 220, a time counter 230, a data storage 240, an injector controller 250, and a current driver 260.

The current sensor 210 is coupled to an injector driving resistor 330 so as to sense a current consumed for driving the injector 300. The current sensor 210 for controlling a current value flowing in the injector 300 is embedded in the drive semiconductor 200 for driving the injector 300.

The selector 220 selects any one of output signals of the voltage sensor and the current sensor 210, and outputs the selected signal to the time counter 230 and the injector controller 250. That is, the selection unit 220 may selectively output the sensed current value of the current sensor 210 to the time counter 230 and the injector controller 250 in response to the sensing current selection signal. In this case, the sensing current selection signal applied to the selection unit 220 may be controlled by the injector controller 250.

The time counter 230 is configured to operate in response to a control signal of the injector controller 250. The time counter 230 is configured count a specific time ranging from a start time at which a drive signal of the injector 300 is received from the MCU 100 to an end time at which an injector driver 310 is turned on. That is, the time counter 230 is configured to count a specific time ranging from a start time at which a drive signal of the injector 300 is received to an end time at which the sensing current received from the selection unit 220 arrives at a predetermined target value.

The injector driver 320 is coupled to an external load 340 so that a turn-on time of the injector driver 310 may be changed according to the external load 340. In this case, the external load 340 may include a resistor R1 and a capacitor C1.

In addition, the injector driver 320 is coupled to an external load 350 so that a turn-on time of the injector driver 320 may be changed according to the external load 350. In this case, the external load 350 may include a resistor R2 and a capacitor C2. That is, the turn-on time of the injector driver 310 or 320 may be changed per channel according to the external load 340 or 350.

The data storage 240 may store data received from the injector controller 250. The data storage 240 may receive data regarding an initial setting value from the MCU 100, and store the received data. In this case, the MCU 100 and the data storage 240 may communicate with the MCU 100 through a Serial Peripheral Interface (SPI) communication.

In addition, the injector controller 250 may receive a drive signal for controlling a drive current of the injector 300 from the MCU 100. The injector controller 250 may adjust a drive current of the injector 300 based on a current value sensed by the current sensor 210 on the basis of the drive signal received from the MCU 100.

That is, the injector controller 250 may receive a current value from the current sensor 210. The injector controller 250 may receive a specific time during which the sensed current value arrives at a target value. In this case, the time 230 may count this specific time during which the sensed current value arrives at a target current value, and the counted information may be stored in the data storage 240.

The injector controller 250 may control turn-on/turn-off operations of the current driver 260 in response to a time during which the sensed current value arrives at a target value, or may establish a drive current of the current driver 260 in response to the above time. The injector driving control device according to the embodiment may quantize a deviation between channels on the basis of information sensed by the current sensor 210 and the time counter 230, and change a drive current setting value of the current driver 260, so that the injector driving control device can compensate for a deviation of the injector drive current between the channels.

In addition, if the sensed current value of the injector 300 deviates from a predetermined value (for example, if the sensed current value exceeds the predetermined value), the injector controller 250 determines the occurrence of an abnormal state in the external load, and thus initializes the drive semiconductor 200.

The driver 260 is configured to control the drive current of the injector driver 310 in response to a drive current setting value received from the injector controller 250. The current driver 260 is configured to include constant-current sources (261, 262).

In this case, the constant-current source 261 is configured as a current source for changing a drive current value of the injector driver 310 in response to the drive current setting signal received from the injector controller 250. In an alternate implementation, the constant-current source 262 is configured as a current source for controlling turn-on/turn-off operations of the current driver 260 in response to on/off signals received from the injector controller 250.

The injector driving control device according to the present disclosure can detect a specific time at which a current begins to flow in the injector 300 using the current sensor 210 embedded in the drive semiconductor 200. The injector driving control device measures the turn-on time of the injector driver 310, compares the measured turn-on time with a predetermined setting value, and enables the drive semiconductor 200 to actively change the drive current setting value of the current driver 260 according to the result of comparison.

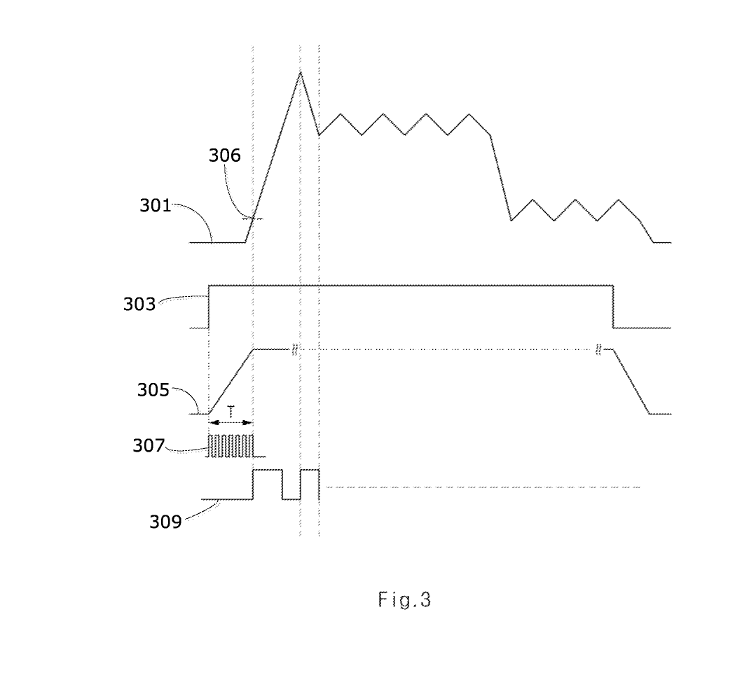

FIG. 3 is a timing diagram including a plurality of graphs 301-309 illustrating operations of the drive semiconductor 200 shown in FIG. 2.

Referring to FIG. 3, a waveform timing graph 301 illustrates a drive current of the injector 300. FIG. 3 also shows a graph 303 of a specific signal for commanding the injector controller 250 to turn on the current driver 260 in response to a drive signal received from the MCU 100, thereby driving the external injector 300.

As can be seen from graph 305 of FIG. 3, if the current driver 260 is driven in response to the drive signal received from the MCU 100, the injector driver 310 starts operation. That is, a gate voltage for turning on a MOS transistor of the injector driver 310 gradually increases according to the drive current received from the current driver 260.

A specific time period T shown in graph 307 of FIG. 3 may range from a start time at which a voltage is input to a gate of the MOS transistor of the injector driver 310 to an end time at which a gate voltage begins to increase up to a predetermined slope level, and may be checked by the time counter 230. In this case, the time counter 230 may be synchronized with a rising edge of the drive signal so as to initiate an internal clock operation.

In other words, a specific time period T may be a predetermined time period that ranges from a start time at which a drive command of the injector driver 310 is received from the MCU 100 to an end time at which the injector 300 is actually driven in a manner that a current flows in the injector 300.

As can be seen from a specific time 306 shown in graph 301 of FIG. 3, a gate voltage of the MOS transistor of the injector driver 310 gradually increases, the injector driver 310 is turned on, and thus the injector 300 begins to be driven.

If a current begins to flow in the injector 300 at the specific time 306, the injector driver 310 is turned on, such that the time counter 230 starts operation.

In addition, after lapse of the specific time 306, the current sensor 210 may sense the drive current of the injector 300 so that the sensed drive current value as shown in graph 309 of FIG. 3 may be output as a high-level signal to the injector controller 250. That is, the current sensor 210 may detect a time point 306 at which the injector driver 310 is turned on and a current begins to flow, and then transmit the sensed current to the injector controller 250.

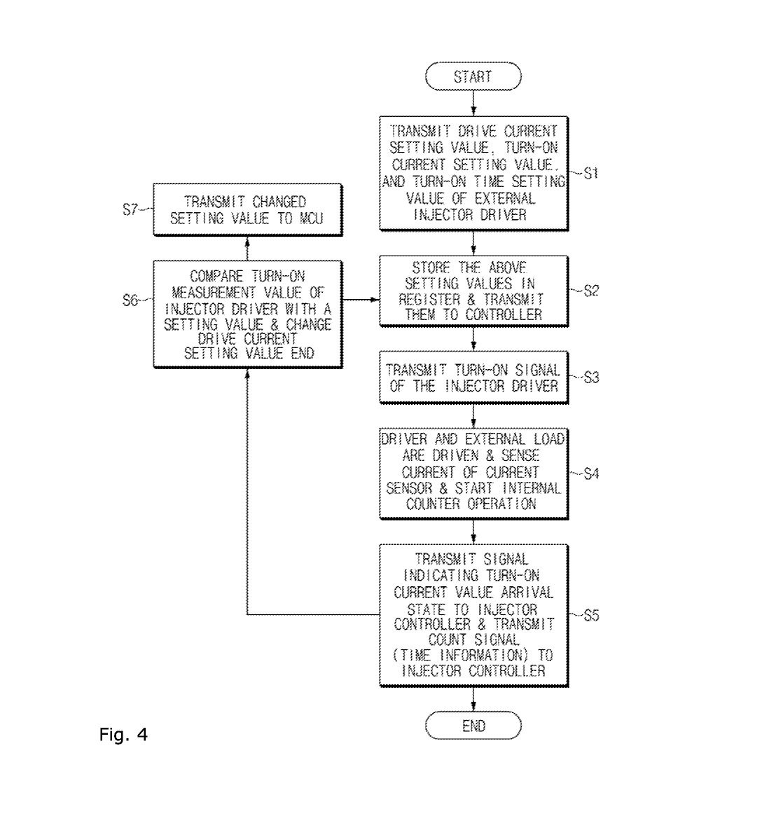

FIG. 4 is a flowchart illustrating operations of the injector driving control device according to the present disclosure.

Referring to FIG. 4, the MCU 100 may transmit a drive current setting value of the current driver 260, a turn-on current setting value of the current driver 260, and a turn-on time setting value of the external injector driver 310 to the drive semiconductor 200, at step S1. The drive semiconductor 200 may store the above setting values received from the MCU 100 in the data storage 240, and transmit the stored setting values to the injector controller 250, at step S2.

Thereafter, the MCU 100 may transmit a drive signal for turning on the external injector driver 310 to the drive semiconductor 200 in step S3. The injector controller 250 may drive the current driver 260 so as to drive the external load 340.

If the external load 340 is driven, the injector driver 310 is turned on so that the injector 300 is driven. If the injector 300 is driven, the injector drive current is sensed by the current sensor 210. The internal time counter 230 contained in the drive semiconductor 200 may count a specific time that ranges from a start time at which the drive signal begins to be activated to an end time at which the injector driver 310 is turned on, at step S4.

Subsequently, if the injector driver 310 is turned on, the time counter 230 may transmit a count signal (i.e., time information) generated for the turned-on injector driver 310 to the injector controller 250. If the injector 300 is driven, the current sensor 210 may transmit the sensed drive current value to the injector controller 250, at step S5.

Subsequently, the injector controller 300 may compare a turn-on time setting value of the external injector driver 310 with a turn-on time of the external injector driver 310. In this case, the turn-on time setting value may be pre-stored in the data storage 240, and a second turn-on time may be substantially measured by the time counter 230.

Therefore, if the two comparison values are different from each other, the injector controller 300 reflects the substantially measured turn-on time of the external injector driver 310 so that the drive current setting value of the current driver 260 is changed, at step S6.

The injector driver 250 may output the changed drive current setting value to the MCU 100, at step S7. That is, the drive current setting value changed by the drive semiconductor 200 may be transferred to the MCU 100 through SPI communication, so that the MCU 100 can recognize modification items of the drive semiconductor 200.

That is, the drive current setting value established in the driver 260 may be changed by the external load 340 coupled to the injector driver 310 or the other external load 350 coupled to the injector driver 320. For example, a load condition may be changed per drive channel according to the external load 340 coupled to the injector driver 310. In this case, a turn-on time of the injector driver 310 may be changed per channel.

For the Euro 6 emission regulations, it is very important to precisely control data so as to reduce a deviation of injector characteristics between the channels. In order to measure the deviation of injector characteristics, time information regarding the injector open- and closing-time points between the channels may be used. In order to constantly maintain a current supply time of each channel when the deviation between injectors of each channel is measured, there is a need to control the current driving capability of the driver 260 in response to the external load condition of the driver 260.

Therefore, in order to confirm a load condition between the channels, the injector driving control device according to the present disclosure can measure a slewing time of the driver 260 using the current sensor 210 contained in the drive semiconductor 200. After the injector driving control device detects a condition for each drive channel in response to the external load 340, the drive current setting value of the current driver 260 is coordinated or adjusted in response to the load condition, resulting in a reduction of a deviation of a turn-on time between drive channels.

As is apparent from the above description, the device for controlling injector driving according to the present disclosure has the following effects.

First, a drive semiconductor directly recognizes a load value of an external injector driving switch, controls a drive current value appropriate for an external load situation, and thus reduces a turn-on time deviation between channels.

Second, the injector driving control device according to the implementations controls a driver on the basis of a drive current value of the injector and time information received from the current sensor, so that the injector driving control device can efficiently control injector characteristics in response to a situation in various applications in terms of Electro Magnetic Interference (EMI) or power consumption.

Although the preferred implementations of the present disclosure have been disclosed for illustrative purposes, those skilled in the art will appreciate that various modifications, additions and substitutions are possible, without departing from the scope and spirit of the present disclosure as disclosed in the accompanying claims.

What is claimed is:

1. A device for controlling a fuel injector of a vehicle engine, comprising:
a micro control unit (MCU) configured to generate a drive signal for controlling an operation of the fuel injector;
a drive semiconductor configured to sense a current flowing in the fuel injector, to measure a time period at an end of which the sensed current reaches a target current value, and to change a drive current setting value of a current driver in response to a result of a comparison between the measured time period and a predetermined time period; and
an injector driver configured to operate the fuel injector in response to an output current of the current driver.

2. The device according to claim 1, wherein the drive semiconductor includes:
a current sensor configured to sense a drive current of the fuel injector;
a time counter configured to measure a specific time period ranging from an input time of the drive signal to a turn-on time of the injector driver;
an injector controller configured to compare the time period measured by the time counter with the predetermined time period so as to change the drive current setting value; and
the current driver is configured to provide the changed drive current to the injector driver in response to the drive current setting value.

3. The device according to claim 2, wherein the drive semiconductor stores the drive current setting value changed by the injector controller in a data storage, and transmits the stored drive current setting value to the micro control unit (MCU).

4. The device according to claim 3, wherein the drive semiconductor, upon receiving at least one drive current setting value of the driver, a turn-on current setting value of the current, and a turn-on time setting value of the injector driver from the micro control unit (MCU), is configured to store the at least one drive current setting value in the data storage.

5. The device according to claim 2, wherein the time counter, upon receiving the drive signal, is configured to sense the specific time period ranging from an input time of the drive signal to an end time at which a gate voltage of a MOS transistor of the injector driver increases up to a predetermined level, and is configured to terminate a time counting operation when the MOS transistor is turned on.

6. A device for controlling a fuel injector of a vehicle engine comprising:
a current sensor configured to sense a drive current of the fuel injector;
a time counter configured to measure a specific time period at an end of which the drive current sensed by the current sensor reaches a target current value;
an injector controller configured to compare the specific period measured by the time counter with a predetermined time period value, and change a drive current setting value according to a result of the comparison; and
a current driver configured to provide the changed drive current setting value to an injector driver for driving fuel injector in response to the drive current setting value.

7. The device according to claim 6, wherein the time counter is configured to measure a time period ranging from a start time at which a drive signal is received from a micro control unit (MCU) to an end time at which the injector driver is turned on.

8. The device according to claim 6, further comprising:
a data storage configured to store the drive current setting value changed by the injector controller; and
a selection unit configured to transmit an output signal of the current sensor to the injector controller in response to a sensing current selection signal.

9. The device according to claim 8, wherein the data storage, upon receiving at least one drive current setting value of the driver, a turn-on current setting value of the current driver, and a turn-on time setting value of the injector driver from a micro control unit (MCU), is configured to store the at least one drive current setting value therein.

10. The device according to claim 6, wherein the time counter is configured to sense a specific time period during which a gate voltage of a MOS transistor of the injector driver increases up to a predetermined level, and is configured to terminate a counting operation when the MOS transistor is turned on.
